(19) United States
(12) Patent Application Publication
(10) Pub. No.: US 2024/0018324 A1
(43) Pub. Date: Jan. 18, 2024

(54) POROUS WET NATURAL FOAMING GEL SOFT MATERIAL, METHOD THEREOF AND APPLICATION THEREOF IN TRANSPORTATION OF FRESH FOOD

(71) Applicant: Zhejiang University, Hangzhou (CN)

(72) Inventors: Li LI, Hangzhou (CN); Zisheng LUO, Hangzhou (CN); Lei WANG, Hangzhou (CN); Xuxu YANG, Hangzhou (CN)

(21) Appl. No.: 17/979,864

(22) Filed: Nov. 3, 2022

(30) Foreign Application Priority Data
Jul. 13, 2022 (CN) 202210819375.5

(51) Int. Cl. C08J 9/14; C08K 13/02

(52) U.S. Cl. CPC C08J 9/142; C08K 13/02; C08J 2389/00

(57) ABSTRACT

Disclosed is a porous wet natural foaming gel soft material, comprising the following raw materials in parts by weight: 1 part to 5 parts of foaming agent; 0.1 part to 1 part of calcium ion releasing agent; 0.2 part to 2 parts of gelling agent; 0.5 part to 1 part of polyol; 0.001 part to 1 part of bacteriostatic agent; and the balance of deionized water supplemented to 100 parts, and the above ingredients are foamed to obtain a hydrogel buffer material, which is the porous wet natural foaming gel soft material. The material has a water content of more than 90%, which can effectively maintain a high wet state of fresh food in transportation. The material is flexible, which reduces a damage caused by friction and collision between a packaging material and a surface of the fresh food during vibration.

### CROSS REFERENCE TO RELATED APPLICATIONS

This application claims foreign priority of Chinese Patent Application No. 202210819375.5, filed on Jul. 13, 2022 in the China National Intellectual Property Administration, the disclosures of all of which are hereby incorporated by reference.

### TECHNICAL FIELD

The present invention belongs to the field of food and material technologies, and particularly to a porous wet natural foaming gel soft material, a method thereof and an application thereof in transportation of fresh food.

### BACKGROUND

At present, existing buffer packaging materials have the following problems.

Problem 1: the existing buffer packaging materials are mostly air-dried materials, with a low water content (being mostly less than 20%) and a poor water-holding capacity (mostly having a surface hydrophobicity), thus being difficult to maintain a high-humidity environment (with a relative air humidity of 85% to 95%) or a water-containing environment, such as fish transportation, required for transportation of fresh food.

Problem 2: the existing buffer packaging materials have rough surfaces, and when transporting fresh food with delicate tissues, such as strawberries with fragile cuticles and fishes with thin sebum, it is easy to cause surface damage due to friction between the packaging materials and the fresh food, which leads to microbial invasion to cause rot and lowers a commodity attribute (breakage rate: damage rates of a commercial vibration reduction box and polyurethane foam in simulated transportation of the present invention are greater than 8%).

Problem 3: the existing buffer packaging materials cannot give good consideration to a buffer performance and a thermal insulation performance, so that a logistics process still needs to be assisted by a cold chain carriage, a coolant or an insulated box, resulting in a high cost and waste of resources.

Problem 4: the existing buffer packaging materials are mostly prepared and molded in advance, without plasticity. Sizes of the fresh food have individual differences, and are inconsistent with fixed sizes of the packaging materials, so that gaps are easily generated, thus resulting in mechanical collision during transportation and accelerating food spoilage.

The following patent publications related to the patent application of the present invention have been found through searching.

1. Biodegradable protein/starch-based thermoplastic composition (CN1115966C): the composition is especially suitable for preparing a low expansion foamed plastic. A metal salt hydrate is added into the composition to improve a mechanical performance of the protein/starch-based thermoplastic composition, and a natural polymer (sodium alginate) is added as a modifier. However, this material is the foamed plastic with a water content of only 17%, so that the material cannot satisfy a demand of special fresh food for high humidity environment. However, the material in the present application has a water content of more than 90%, so that the material can be used for transportation of fishes.

2. Preparation method of natural high-strength sodium alginate double-crosslinked hydrogel film (CN113336987A): the double-crosslinked hydrogel film takes sodium alginate as a matrix, deacetylated crab shell powder as a crosslinking agent, and gluconolactone as a calcium ion releasing agent in the crab shell powder to promote the crosslinking of a sodium alginate gel. Meanwhile, exposed amino of chitin in the crab shell powder subjected to deacetylation may have a polyelectrolyte interaction with carboxyl of the sodium alginate to finally obtain the double-crosslinked hydrogel film. The hydrogel is a double-crosslinked hydrogel network formed with chitin and the sodium alginate.

However, a double network is formed with protein and the sodium alginate in the present application, so that raw material ingredients are different, and an amphiphilic performance of the protein may provide an excellent foaming performance. In addition, the calcium ion releasing agent in the present application not only releases CaCO₃ and Ca₁₀(PO₄)₆(OH)₂ of gluconolactone, but also releases CaO₂ by itself

3. Protein-chitosan complex coacervation food microcapsule system and preparation method thereof (CN105010934A): protein, chitosan and sodium alginate are mixed by stirring at a low speed in the system, but a preparation method of a protein-sodium alginate compound is different from that in the present application. In the present application, a nano-compound is formed by ultrasonic treatment and an emulsion freeze-thaw method, which improves a foaming performance of the compound.

4. Plant-source ultralight damping multi-effect buffer material and preparation method thereof (CN113201169A): the material takes a natural plant-derived pomelo white pulp as a raw material, which is ground into powder, and CaCl₂ as a crosslinking agent, is added with carboxymethyl chitosan as a humectant and an antibacterial agent, and is prepared into a paste, with a plasticity. However, this material has a low water content, so that it is difficult to maintain the high humidity environment required for transporting a part of fresh food.

5. Protein composition and use thereof in restructured meat and food products (CN101489408B): the hydrated and chopped protein composition may be a soybean protein isolate in the composition, and the composition may be further combined with starch, flour and fiber to prepare restructured meat, vegetable and fruit products, so as to obtain a muscle-like texture. The target problem is to improve a food texture, while the present application is used to prepare a wet soft packaging material. Moreover, a technical method is different, the compound is formed with the soybean protein isolate and the sodium alginate in this invention, with a mechanical property came from the double network gel of soybean protein isolate/alginic acid and a porous structure, which is different from the present application.

The patent application of the present invention is essentially different from the above patent publications by comparison.

### SUMMARY

The present invention aims to overcome the defects in the prior art, and provide a porous wet natural foaming gel soft material, a method thereof and an application thereof in transportation of fresh food.

The technical solutions used in the present invention to solve the technical problems are as follows.

A porous wet natural foaming gel soft material comprises the following raw materials in parts by weight:

1 part to 5 parts of foaming agent;

0.1 part to 1 part of calcium ion releasing agent;

0.2 part to 2 parts of gelling agent;

0.5 part to 1 part of polyol;

0.001 part to 1 part of bacteriostatic agent; and

the balance of deionized water supplemented to 100 parts, wherein the above ingredients are foamed to obtain a hydrogel buffer material, which is the porous wet natural foaming gel soft material.

Further, the foaming agent is a soybean protein isolate-sodium alginate compound, and a preparation method of the foaming agent specifically comprises: activating a soybean protein isolate in an NH₃ plasma for 5 minutes to 30 minutes, adding the activated soybean protein isolate into deionized water, magnetically stirring the mixture until the mixture is fully dissolved to prepare into a soybean protein isolate solution with a mass concentration of 1% to 6%, treating the solution by an ultrasonic wave at a power of 600 W for 10 minutes, then adding a sodium alginate solution with a mass concentration of 1% to 3% in a volume ratio of 1:1, homogenizing the mixture by a 50 MPa high-pressure homogenizer for thrice, fully hydrating the homogenized mixture overnight, and then freeze-drying the hydrated product to obtain the soybean protein isolate-sodium alginate compound.

Further, the calcium ion releasing agent is insoluble calcium salt;

or, the gelling agent is weak acid;

or, the polyol is selected from 1,2-pentanediol, 1,2-hexanediol and glycerol for adjusting latent heat of phase change, and has moisturizing and bacteriostasis functions at the same time;

or, the bacteriostatic agent is selected from p-hydroxyacetophenone, potassium sorbate and plant essential oil.

Further, the insoluble calcium salt is selected from CaO₂, CaCO₃ and Ca₁₀(PO₄)₆(OH)₂, and the calcium salt is selected according to a gas atmosphere required for transporting articles; and

the weak acid is selected from gluconolactone, D-Glucoheptono-1,4-lactone and lactobionic acid.

A preparation method of the porous wet natural foaming gel soft material above comprises the following steps of:

(1) adding the foaming agent into the deionized water, magnetically stirring the mixture until the mixture is fully dissolved, and treating the dissolved mixture by an ultrasonic wave at a power of 600 W for 5 minutes;

(2) beating the mixture by a stirrer at a high speed until wet foaming is realized to obtain prefabricated gel foam; and

(3) adding the calcium ion releasing agent, the gelling agent, the polyol and the bacteriostatic agent into the prefabricated gel foam, stirring the mixture evenly, and standing to form a gel to obtain the porous wet natural foaming gel soft material.

An application of the porous wet natural foaming gel soft material above in transportation of fresh food is provided.

An application of the porous wet natural foaming gel soft material above serving as or preparing a packaging material of fresh food is provided.

An application of the porous wet natural foaming gel soft material above serving as a wet soft material for packaging fresh food is provided.

An application method of the porous wet natural foaming gel soft material above is provided, and steps comprise:

injecting the natural foaming gel soft material into a packaging container, putting fresh food to be transported into the packaging container, and sealing an opening of the container to wait for gel formation, wherein the gel formation is carried out by standing, the gel formation lasts for 1 hour to 2 hours, and transportation is carried out after the gel formation.

An application method of the porous wet natural foaming gel soft material above is provided, and steps comprise:

using the natural foaming gel soft material as a coolant, pre-cooling packaged fresh food in a low-temperature environment before transportation during application, and using the porous wet natural foaming gel soft material to maintain a low temperature during transportation.

The advantages and the positive effects of the present invention are as follows.

1. The foaming gel soft material of the present invention has the water content of more than 90%, which can effectively maintain a high wet state of fresh food in transportation.

2. The porous hydrogel prepared by the present invention is a flexible material with a smooth surface (a friction coefficient may reach 0.084±0.003) and a soft texture (a modulus is 2.3 kPa to 2.8 kPa), which can reduce damages caused by friction and collision between the packaging material and the surface of the fresh food in vibration, and compared commercial materials, a damage index of the fresh food can be reduced by 33% to 60% in simulated transportation.

3. In the preparation method of the foaming agent of the material of the present invention, the soybean protein isolate is treated by the NH₃ plasma collaborated with the ultrasonic wave to form a nano-compound with the sodium alginate, a foaming performance of the compound is increased by 20% to 30%, and a foam stability is improved.

4. A soybean protein isolate and sodium alginate self-assembled double-network hydrogel formed after foaming of the material of the present invention by the foaming agent has an excellent buffering performance, and more than 70% mechanical dissipation, and still retains 51% mechanical dissipation after 200 cycles.

5. The material of the present invention is foamy initially, gradually forms the gel within 1 hour to 3 hours, has a plasticity, and effectively reduces a gap between the packaging material and the fresh food, so that the packaging material is tightly attached to the fresh food and fixes the fresh food; and the gel formation time is controlled by controlling proportions of the gelling agent and the calcium ion releasing agent.

6. The material of the present invention forms a gas phase, liquid phase and solid phase system with the foam and the gel, has a high specific heat capacity (3956±49 J kg⁻¹ K⁻¹), may maintain a stability of temperature of surrounding environment of food in cold chain transportation, and is beneficial for keeping a low temperature.

7. Organic macromolecules such as the sodium alginate and the inorganic salt in the material of the present invention endow the material with high latent heat of phase change (201±54 J g-1), so that the material may effectively maintain a low temperature state of the fresh food in transportation.

8. O₂ and CO₂ can be released synchronously during slow release of calcium ions in the material of the present invention, which can change the gas atmosphere in the material, when a concentration of O₂ in environment needs to be increased, the calcium ion releasing agent may be CaO₂, and when a concentration of CO₂ in environment needs to be increased, the calcium ion releasing agent may be CaCO₃.

### BRIEF DESCRIPTION OF THE DRAWINGS

FIG. 1 shows a stability kinetics curve of a foaming gel soft material prepared in Embodiment 1 of the present invention;

FIG. 2 shows a stability kinetics curve of a foaming gel soft material prepared in Embodiment 2 of the present invention;

FIG. 3 shows a stability kinetics curve of a foaming gel soft material prepared in Embodiment 3 of the present invention;

FIG. 4 is a DSC scanning chart of different materials in the present invention;

FIG. 5 shows stress-strain curves of cyclic loading in the present invention;

FIG. 6 is an image of micro-structures before and after the cyclic loading in the present invention;

FIG. 7 is an image of different packages of strawberries in the present invention;

FIG. 8 is a schematic diagram of damages of strawberries with different packages in simulated transportation and a drop experiment in the present invention; and

FIG. 9 shows damage indexes of the strawberries with different packages in the simulated transportation and the drop experiment in the present invention.

### DETAILED DESCRIPTION

An embodiment of the present invention is described in detail hereinafter. It should be noted that the embodiment is descriptive and nonrestrictive, and cannot limit the scope of protection of the present invention.

Unless otherwise specified, the raw materials used in the present invention are all conventional products commercially available. Unless otherwise specified, the methods used in the present invention are all conventional methods in the art.

A porous wet natural foaming gel soft material comprises the following raw materials in parts by weight:

1 part to 5 parts of foaming agent;

0.1 part to 1 part of calcium ion releasing agent;

0.2 part to 2 parts of gelling agent;

0.5 part to 1 part of polyol;

0.001 part to 1 part of bacteriostatic agent; and

the balance of deionized water supplemented to 100 parts, wherein the above ingredients are foamed to obtain a hydrogel buffer material, which is the porous wet natural foaming gel soft material.

Preferably, the foaming agent is a soybean protein isolate-sodium alginate compound, and a preparation method of the foaming agent specifically comprises: activating a soybean protein isolate in an NH₃ plasma for 5 minutes to 30 minutes, adding the activated soybean protein isolate into deionized water, magnetically stirring the mixture until the mixture is fully dissolved to prepare into a soybean protein isolate solution with a mass concentration of 1% to 6%, treating the solution by an ultrasonic wave at a power of 600 W for 10 minutes, then adding a sodium alginate solution with a mass concentration of 1% to 3% in a volume ratio of 1:1, homogenizing the mixture by a 50 MPa high-pressure homogenizer for thrice, fully hydrating the homogenized mixture overnight, and then freeze-drying the hydrated product to obtain the soybean protein isolate-sodium alginate compound.

Preferably, the calcium ion releasing agent is insoluble calcium salt;

or, the gelling agent is weak acid;

or, the polyol is selected from 1,2-pentanediol, 1,2-hexanediol and glycerol for adjusting latent heat of phase change, and has moisturizing and bacteriostasis functions at the same time;

or, the bacteriostatic agent is selected from p-hydroxyacetophenone, potassium sorbate and plant essential oil.

Preferably, the insoluble calcium salt is selected from CaO₂, CaCO₃ and Ca10(PO₄)₆(OH)₂, and the calcium salt is selected according to a gas atmosphere required for transporting articles; and

the weak acid is selected from gluconolactone, D-Glucoheptono-1,4-lactone and lactobionic acid.

A preparation method of the porous wet natural foaming gel soft material above comprises the following steps of:

(1) adding the foaming agent into the deionized water, magnetically stirring the mixture until the mixture is fully dissolved, and treating the dissolved mixture by an ultrasonic wave at a power of 600 W for 5 minutes;

(2) beating the mixture by a stirrer at a high speed until wet foaming is realized to obtain prefabricated gel foam; and

(3) adding the calcium ion releasing agent, the gelling agent, the polyol and the bacteriostatic agent into the prefabricated gel foam, stirring the mixture evenly, and standing to form a gel to obtain the porous wet natural foaming gel soft material.

An application of the porous wet natural foaming gel soft material above in transportation of fresh food is provided.

An application of the porous wet natural foaming gel soft material above serving as or preparing a packaging material of fresh food is provided.

An application of the porous wet natural foaming gel soft material above serving as a wet soft material for packaging fresh food is provided.

An application method of the porous wet natural foaming gel soft material above is provided, and steps comprise:

injecting the natural foaming gel soft material into a packaging container, putting fresh food to be transported into the packaging container, and sealing an opening of the container to wait for gel formation, wherein the gel formation is carried out by standing, the gel formation lasts for 1 hour to 2 hours, and transportation is carried out after the gel formation.

An application method of the porous wet natural foaming gel soft material above is provided, and steps comprise:

using the natural foaming gel soft material as a coolant, pre-cooling packaged fresh food in a low-temperature environment before transportation during application, and using the porous wet natural foaming gel soft material to maintain a low temperature during transportation.

Specifically, related preparation and detection embodiments are as follows.

### Embodiment 1

A preparation method of a foaming gel soft material comprised the following steps.

(1) A soybean protein isolate was added into deionized water, and magnetically stirred until the mixture was fully dissolved to prepare into a soybean protein isolate solution with a mass concentration of 4%, the solution was treated by an ultrasonic wave at a power of 600 W for 10 minutes, and then a sodium alginate solution with a mass concentration of 2% in a volume ratio of 1:1 was added, homogenized by a 50 MPa high-pressure homogenizer for thrice, fully hydrated overnight, and then freeze-dried to obtain the soybean protein isolate-sodium alginate compound.

(2) 3 parts of soybean protein isolate-sodium alginate compound were added into the deionized water, magnetically stirred until the mixture was fully dissolved, and treated by an ultrasonic wave at a power of 600 W for 5 minutes.

(3) The mixture was beaten by a stirrer at a high speed until wet foaming was realized to obtain prefabricated gel foam.

(4) 0.3 part of CaCO₃, 0.6 part of gluconolactone, 1 part of glycerol and 0.05 part of clove essential oil were added into the prefabricated gel foam, stirred evenly, and stood for gel formation to obtain the foaming gel soft material.

The above parts were all parts by weight, and a sum of the parts by weight of the soybean protein isolate-sodium alginate compound, the deionized water, the CaCO₃, the gluconolactone, the glycerol and the clove essential oil was 100 parts.

Foaming rate=foam volume/solution volume×100%.

A stability kinetics curve of the prefabricated gel foam was measured by a TURBISCAN Lab multiple light scatterometer.

A storage modulus G′ and a loss modulus G″ of the gel were measured by a rheometer, a test rotor was a flat rotor, a test speed was 1 rad/s, tan δ=G″/G′, and tan δ equal to 1 was taken as gel solidification time.

TABLE 1
Characteristics of material

| Foaming rate | 251.7 ± 3.5% | |
|---|---|---|
| Density | 0.39 | g/cm³ |
| Gel formation time | 74 | minutes |

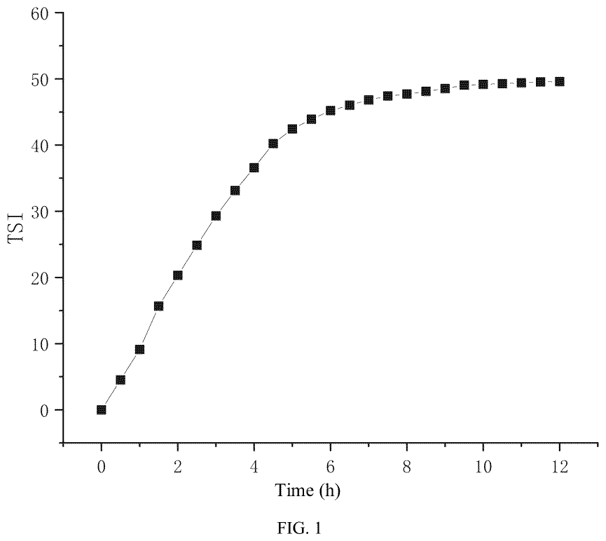

It can be seen from Table 1 that the foaming rate of the soybean protein isolate-sodium alginate compound formed by pre-treating the soybean protein isolate by the ultrasonic wave at the power of 600 W for 10 minutes during foaming is 251.7%. The gel formation time is 74 minutes, and the density of the material is 0.39 g/cm³. It can be seen from FIG. 1 that a TSI index of the foam can reach 49.59 after 12 hours, and the foam is unstable.

### Embodiment 2

A preparation method of a foaming gel soft material comprised the following steps.

(1) A soybean protein isolate was put into a plasma treater, and treated with an NH₃ plasma for 10 minutes under a base pressure of less than 3 Pa, the activated soybean protein isolate was added into deionized water, and magnetically stirred until the mixture was fully dissolved to prepare into a soybean protein isolate solution with a mass concentration of 4%, and then a sodium alginate solution with a mass concentration of 2% in a volume ratio of 1:1 was added, homogenized by a 50 MPa high-pressure homogenizer for thrice, fully hydrated overnight, and then freeze-dried to obtain the soybean protein isolate-sodium alginate compound.

(2) 3 parts of soybean protein isolate-sodium alginate compound were added into the deionized water, magnetically stirred until the mixture was fully dissolved, and treated by an ultrasonic wave at a power of 600 W for 5 minutes.

(3) The mixture was beaten by a stirrer at a high speed until wet foaming was realized to obtain prefabricated gel foam.

(4) 0.25 part of Ca₁₀(PO₄)₆(OH)₂, 0.7 part of D-Glucoheptono-1,4-lactone, 1 part of glycerol and 0.001 part of potassium sorbate were added into the prefabricated gel foam, stirred evenly, and stood for gel formation to obtain the foaming gel soft material.

The above parts were all parts by weight, and a sum of the parts by weight of the soybean protein isolate-sodium alginate compound, the deionized water, the Ca₁₀(PO₄)₆(OH)₂, the D-Glucoheptono-1,4-lactone, the glycerol and the potassium sorbate was 100 parts.

Foaming rate=foam volume/solution volume×100%.

A stability kinetics curve of the prefabricated gel foam was measured by a TURBISCAN Lab multiple light scatterometer.

A storage modulus G′ and a loss modulus G″ of the gel were measured by a rheometer, a test rotor was a flat rotor, a test speed was 1 rad/s, tan δ=G″/G′, and tan δ equal to 1 was taken as gel solidification time.

TABLE 2
Characteristics of material

| Foaming rate | 171.2 ± 4.2% | |
|---|---|---|
| Density | 0.58 | g/cm³ |
| Gel formation time | 68 | min |

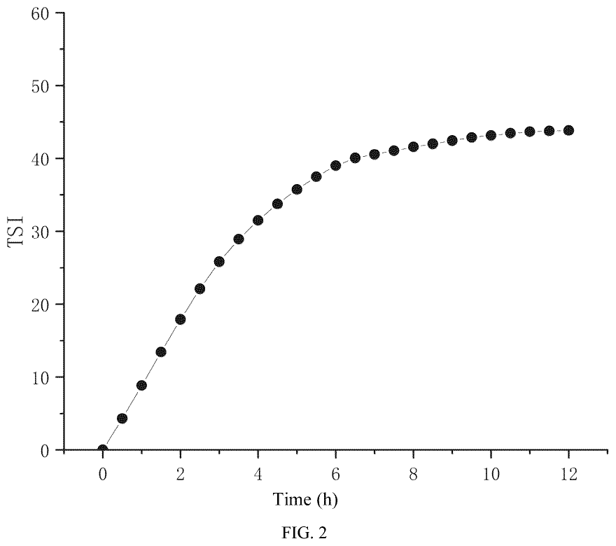

It can be seen from Table 2 that the foaming rate of the soybean protein isolate-sodium alginate compound formed by treating the soybean protein isolate with the NH₃ plasma for 10 minutes during foaming is 171.2%, and the foaming rate is lower than that in Embodiment 1. The gel formation time is 68 minutes, and the density of the material is 0.58 g/cm³. It can be seen from FIG. 2 that a TSI index of the foam is 43.83 after 12 hours, which is lower than that in Embodiment 2, and the foam is relatively stable. It is indicated that the compound formed with the soybean protein isolate treated with the NH₃ plasma for 10 minutes and the sodium alginate has the foaming rate lower than that of ultrasonic pretreatment during foaming, resulting in a higher density of the final material, but the formed foam is more stable.

### Embodiment 3

A preparation method of a porous wet natural foaming gel soft material comprised the following steps.

(1) A soybean protein isolate was put into a plasma treater, and treated with an NH₃ plasma for 10 minutes under a base pressure of less than 3 Pa, the activated soybean protein isolate was added into deionized water, and magnetically stirred until the mixture was fully dissolved to prepare into a soybean protein isolate solution with a mass concentration of 4%, the solution was treated by an ultrasonic wave at a power of 600 W for 10 minutes, and then a sodium alginate solution with a mass concentration of 2% in a volume ratio of 1:1 was added, homogenized by a 50 MPa high-pressure homogenizer for thrice, fully hydrated overnight, and then freeze-dried to obtain the soybean protein isolate-sodium alginate compound.

(2) 3 parts of soybean protein isolate-sodium alginate compound were added into the deionized water, magnetically stirred until the mixture was fully dissolved, and treated by an ultrasonic wave at a power of 600 W for 5 minutes.

(3) The mixture was beaten by a stirrer at a high speed until wet foaming was realized to obtain prefabricated gel foam.

(4) 0.3 part of CaCO₃, 0.7 part of gluconolactone, 1 part of glycerol and 0.05 part of clove essential oil were added into the prefabricated gel foam, stirred evenly, and stood for gel formation to obtain the porous wet natural foaming gel soft material.

The above parts were all parts by weight, and a sum of the parts by weight of the soybean protein isolate-sodium alginate compound, the deionized water, the CaCO₃, the gluconolactone, the glycerol and the clove essential oil was 100 parts.

Foaming rate=foam volume/solution volume×100%.

A stability kinetics curve of the prefabricated gel foam was measured by a TURBISCAN Lab multiple light scatterometer.

A storage modulus G′ and a loss modulus G″ of the gel were measured by a rheometer, a test rotor was a conical rotor, a test speed was 1 rad/s, tan δ=G″/G′, and tan δ equal to 1 was taken as gel solidification time.

A surface friction coefficient was measured by a rheometer, a test rotor was a flat rotor, a test speed was 0.5 rad/s, and the friction coefficient was calculated according to μ=4T/3F_{N}R, wherein T was a torque, F_{N} was a normal force, and R was a contact radius.

A specific heat capacity was measured by a Mettler differential scanning calorimeter, and a scanning temperature was 10° C. to 40° C., with air as the control.

Latent heat of phase change was measured by a Mettler differential scanning calorimeter, a scanning temperature was −40° C. to 40° C., and a heating rate was 10° C./min, with polyurethane foam and polyethylene foam as the comparisons.

The obtained material was subjected to 200 cyclic loading experiments by a stretcher at a speed of 5 mm/s under a strain of 0.5. Stress-strain curves of cyclic loading of the material were measured.

Loaded and unloaded hydrogel materials were frozen in liquid nitrogen, and then freeze-dried by a vacuum freeze-dryer, and then micro-structures of the materials were observed by a scanning electron microscope.

TABLE 3
Characteristics of material

| Foaming rate | 343.5 ± 5.6% | |
|---|---|---|
| Density | 0.29 | g/cm³ |
| Gel formation time | 61 | min |
| Friction coefficient | 0.084 ± 0.003 | |
| Modulus | 2.3 ± 0.02 | kPa |
| Specific heat capacity | 3956 ± 49 | J kg⁻¹ K⁻¹ |
| Latent heat of phase change | 201 ± 54 | J g⁻¹ |

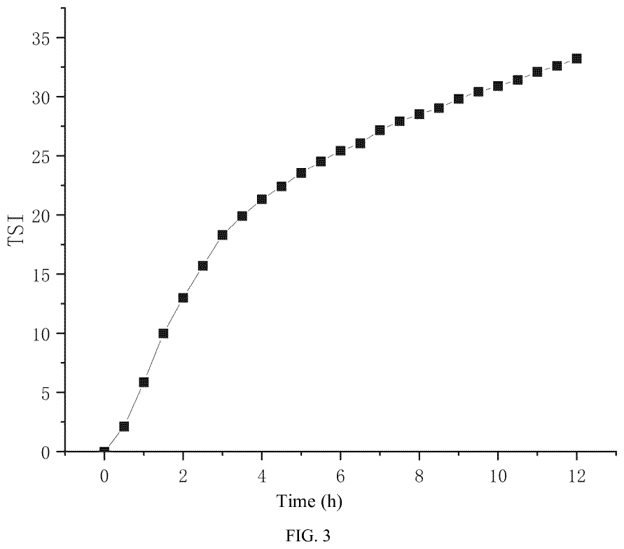

It can be seen from Table 3 that the foaming rate of the soybean protein isolate-sodium alginate compound formed by pre-treating the soybean protein isolate through the NH₃ plasma and the ultrasonic wave at the power of 600 W during foaming may reach 343.5%, and the foaming rate is significantly higher than those in Embodiment 1 and Embodiment 2. The density of the material is 0.29 g/cm³, which is lower than those of the materials prepared in Embodiment 1 and Embodiment 2. It can be seen from FIG. 3 that a TSI index of the foam may be 33.23 after 12 hours, which is significantly lower than those in Embodiment 1 and Embodiment 2, and the foam is relatively stable. It is indicated that the collaborated treatment of the soybean protein isolate through the NH₃ plasma and the ultrasonic wave is beneficial for improving the foaming rate of the soybean protein isolate-sodium alginate compound, thus reducing the density of the packaging material, and improving the stability of the foam at the same time.

In addition, it can be seen from Table 3 that the gel formation time is 61 minutes, which is shorter than that in Embodiment 1. This is because an addition amount of the gluconolactone is increased in Embodiment 3, thus it can be seen that the gel formation time may be controlled by adjusting a proportion of a gelling agent.

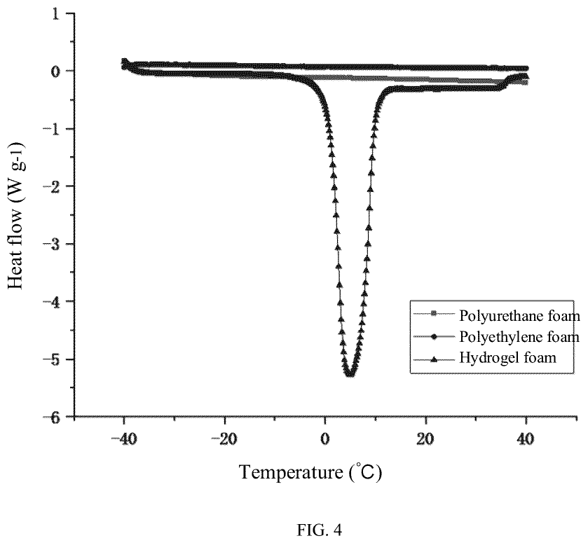

It can be seen from FIG. 4 that the prepared foaming hydrogel soft material has a larger phase-change endothermic peak compared with commonly used polyurethane foam and polyethylene foam. Meanwhile, the material has larger latent heat of phase change (3956±49 J kg⁻¹ K⁻¹), which indicates that the material may be used as a coolant.

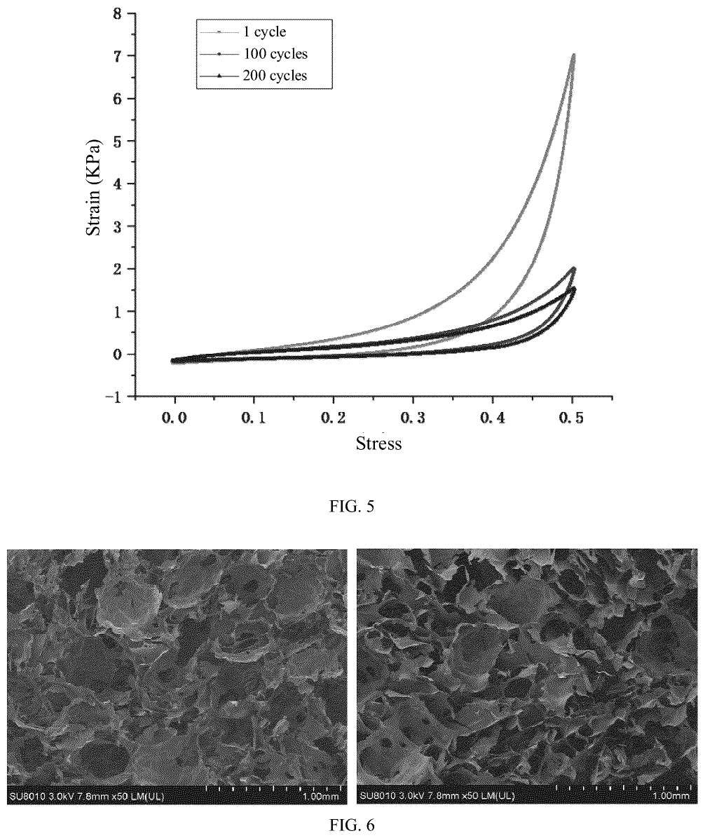

It can be seen from FIG. 5 that the prepared foaming hydrogel soft material still has certain energy dissipation after cyclic loading for 200 times, thus having a buffering effect on an external force.

It can be seen from FIG. 6 that the prepared foaming hydrogel soft material shows a porous structure before loading the external force, and the porous structure is collapsed after cyclic loading for 200 times, thus dissipating the external force.

### Embodiment 4

A preparation method of a porous wet natural foaming gel soft material comprised the following steps.

(1) A soybean protein isolate was put into a plasma treater, and treated with an NH₃ plasma for 10 minutes under a base pressure of less than 3 Pa, the activated soybean protein isolate was added into deionized water, and magnetically stirred until the mixture was fully dissolved to prepare into a soybean protein isolate solution with a mass concentration of 4%, the solution was treated by an ultrasonic wave at a power of 600 W for 10 minutes, and then a sodium alginate solution with a mass concentration of 2% in a volume ratio of 1:1 was added, homogenized by a 50 MPa high-pressure homogenizer for thrice, fully hydrated overnight, and then freeze-dried to obtain the soybean protein isolate-sodium alginate compound.

(2) 3 parts of soybean protein isolate-sodium alginate compound were added into the deionized water, magnetically stirred until the mixture was fully dissolved, and treated by an ultrasonic wave at a power of 600 W for 5 minutes.

(3) The mixture was beaten by a stirrer at a high speed until wet foaming was realized to obtain prefabricated gel foam.

(4) 0.3 part of CaCO₃, 0.7 part of gluconolactone, 1 part of glycerol and 0.05 part of clove essential oil were added into the prefabricated gel foam, stirred evenly, and injected into a packaging container, freshly picked strawberries were put into the container, an opening of the container was sealed, and the mixture was stood for gel formation to obtain the strawberries packaged by the porous wet natural foaming gel soft material.

The above parts were all parts by weight, and a sum of the parts by weight of the soybean protein isolate-sodium alginate compound, the deionized water, the CaCO₃, the gluconolactone, the glycerol and the clove essential oil was 100 parts.

(5) The packaged strawberries were divided into two groups, wherein one group was vibrated for 1 hour by a simulated transportation machine as a simulated transportation experiment, and the other group was dropped at a height of 1 m for 10 times as a drop experiment, and unpackaged strawberries were used as a control group during the experiments. The polyurethane foam and a commercial vibration reduction package were used as comparison groups.

Measurement of damage indexes of strawberries: the strawberries were divided into five grades according to damage degrees. In Grade 0, the strawberries had no damage;

in Grade 1, a damaged area of the strawberries was less than ¼ of a total area; in Grade 2, the damaged area of the strawberries was ¼ to 2 of the total area; in Grade 3, the damaged area of the strawberries was ½ to ¾ of the total area; and in Grade 4, the damaged area of the strawberries was more than ¾ of the total area. Damage rate=Σᵢ₌₀⁴LᵢNᵢ/LₕNₜ, wherein Lᵢ represented a grade i, Lₕ represented a highest grade, Nᵢ represented a number of strawberries in the grade i, and Nₜ represented a total number of strawberries.

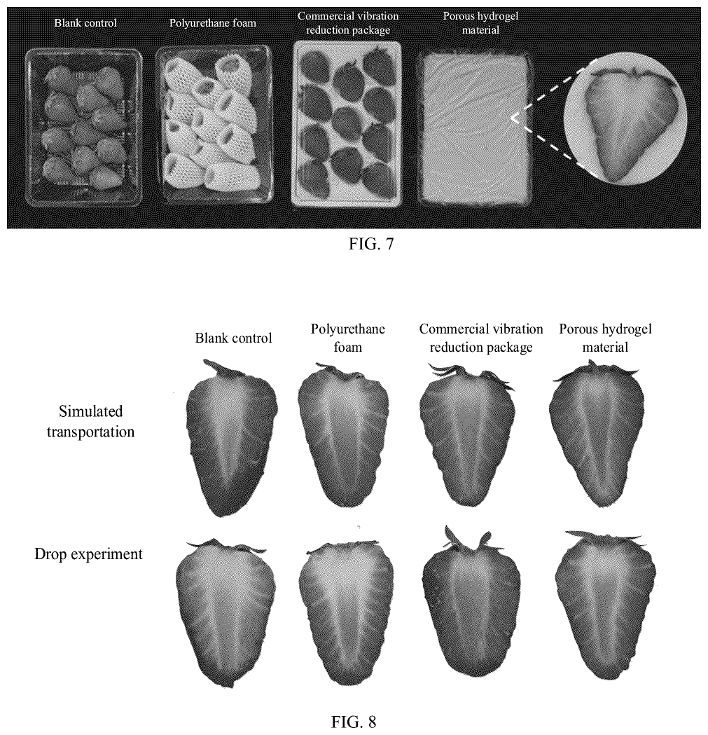

It can be seen from FIG. 7 that, compared with other packages, the porous wet natural foaming gel can cover all angles of the strawberries, reduce vibration in all directions, and adapt to various sizes and shapes of fruits.

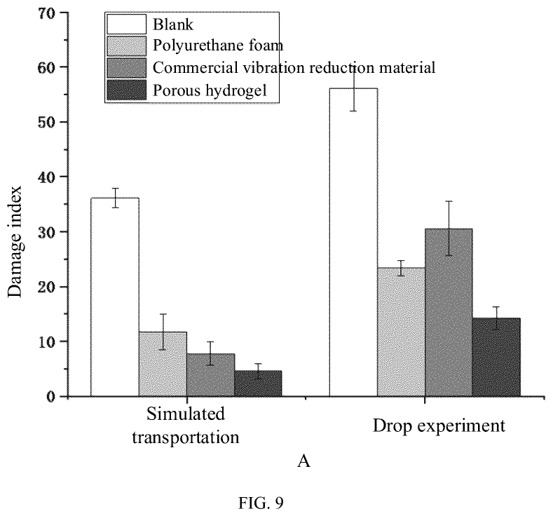

The prepared porous wet natural foaming gel soft material is compared with the two commonly used packaging materials, which are namely the polyurethane foam and the polyethylene foam to carry out the simulated transportation and the drop experiment. It can be seen from FIG. 8 to FIG. 9 that the package by the porous wet natural foaming gel soft material can significantly reduce the damages of the strawberries produced during simulated transportation and dropping, so that the effect of the material is obviously better than those of the packaging materials commonly used at present.

Although the embodiments of the present invention have been disclosed for illustrative purposes, those skilled in the art may understand that various alternatives, changes and modifications are possible without departing from the spirit and scope of the present invention and the appended claims. Therefore, the scope of the present invention is not limited to the contents disclosed in the embodiments.

1. A porous wet natural foaming gel soft material, comprising the following raw materials in parts by weight:
1 part to 5 parts of foaming agent;
0.1 part to 1 part of calcium ion releasing agent;
0.2 part to 2 parts of gelling agent;
0.5 part to 1 part of polyol;
0.001 part to 1 part of bacteriostatic agent; and
the balance of deionized water supplemented to 100 parts, wherein the above ingredients are foamed to obtain a hydrogel buffer material, which is the porous wet natural foaming gel soft material.

2. The porous wet natural foaming gel soft material according to claim 1, wherein the foaming agent is a soybean protein isolate-sodium alginate compound, and a preparation method of the foaming agent specifically comprises: activating a soybean protein isolate in an NH₃ plasma for 5 minutes to 30 minutes, adding the activated soybean protein isolate into deionized water, magnetically stirring the mixture until the mixture is fully dissolved to prepare into a soybean protein isolate solution with a mass concentration of 1% to 6%, treating the solution by an ultrasonic wave at a power of 600 W for 10 minutes, then adding a sodium alginate solution with a mass concentration of 1% to 3% in a volume ratio of 1:1, homogenizing the mixture by a 50 MPa high-pressure homogenizer for thrice, fully hydrating the homogenized mixture overnight, and then freeze-drying the hydrated product to obtain the soybean protein isolate-sodium alginate compound.

3. The porous wet natural foaming gel soft material according to claim 1, wherein the calcium ion releasing agent is insoluble calcium salt;
or, the gelling agent is weak acid;
or, the polyol is selected from 1,2-pentanediol, 1,2-hexanediol and glycerol;
or, the bacteriostatic agent is selected from p-hydroxyacetophenone, potassium sorbate and plant essential oil.

4. The porous wet natural foaming gel soft material according to claim 3, wherein the insoluble calcium salt is selected from CaO₂, CaCO₃ and Ca₁₀(PO₄)₆(OH)₂, and the calcium salt is selected according to a gas atmosphere required for transporting articles; and
the weak acid is selected from gluconolactone, D-Glucoheptono-1,4-lactone and lactobionic acid.

5. A preparation method of the porous wet natural foaming gel soft material according to claim 1, comprising the following steps of:
(1) adding the foaming agent into the deionized water, magnetically stirring the mixture until the mixture is fully dissolved, and treating the dissolved mixture by an ultrasonic wave at a power of 600 W for 5 minutes;
(2) beating the mixture by a stirrer at a high speed until wet foaming is realized to obtain prefabricated gel foam; and
(3) adding the calcium ion releasing agent, the gelling agent, the polyol and the bacteriostatic agent into the prefabricated gel foam, stirring the mixture evenly, and standing to form a gel to obtain the porous wet natural foaming gel soft material.

6. An application of the porous wet natural foaming gel soft material according to claim 1 in transportation of fresh food.

7. An application of the porous wet natural foaming gel soft material according to claim 1 serving as or preparing a packaging material of fresh food.

8. An application of the porous wet natural foaming gel soft material according to claim 1 serving as a wet soft material for packaging fresh food.

9. An application method of the porous wet natural foaming gel soft material according to claim 1, comprising the following steps of:
injecting the natural foaming gel soft material into a packaging container, putting fresh food to be transported into the packaging container, and sealing an opening of the container to wait for gel formation, wherein the gel formation is carried out by standing, the gel formation lasts for 1 hour to 2 hours, and transportation is carried out after the gel formation.

10. An application method of the porous wet natural foaming gel soft material according to claim 1, comprising the following steps of:
using the natural foaming gel soft material as a coolant, pre-cooling packaged fresh food in a low-temperature environment before transportation during application, and using the porous wet natural foaming gel soft material to maintain a low temperature during transportation.
